(19) United States
(12) Patent Application Publication
(10) Pub. No.: US 2010/0303218 A1
(43) Pub. Date: Dec. 2, 2010

(54) IMAGE DISPLAY APPARATUS, IMAGE DISPLAY METHOD, AND RECORDING MEDIUM RECORDING AN IMAGE DISPLAY PROGRAM

(75) Inventor: Megumi Hata, Aichi-gun (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKA KAISHA, Nagoya-shi (JP)

(21) Appl. No.: 12/789,078

(22) Filed: May 27, 2010

(30) Foreign Application Priority Data
May 29, 2009 (JP) 2009-131517

(51) Int. Cl. H04M 11/00

(52) U.S. Cl. 379/93.17

(57) ABSTRACT

An image display apparatus acquires other-party device history information that associates other-party device information with call history information that is records of calls, the other-party device information being related to devices of other parties that have talked with a user of the image display apparatus on the phone through a telephone device.

Further, the image display apparatus selects the other-party device information about devices of other parties that talked with the user on the phone a predetermined period of time ago or earlier, by referring to the other-party device history information thus acquired.

Furthermore, the image display apparatus acquires image information related to the other-party device information thus selected, and causes an image according to the image information thus acquired, to be displayed.

The entire disclosure of the Japanese Patent Application No. 2009-131517, including the specification, the scope of claims, drawings, and abstract, filed on May 29, 2009 is incorporated herein by reference in its entirety.

### BACKGROUND OF THE INVENTION

1. Field of the Invention

The present invention relates to an image display apparatus, an image display method, and a recording medium recording an image display program for automatically checking call histories.

2. Description of the Related Art

Image display apparatuses each having a storage function to store telephone books, call histories, image information, and the likes, as well as a call function, have been conventionally used. In recent years, such image display apparatuses each have a new function to provide users of the image information apparatuses with chances to review image information and the likes stored in the past in the image display apparatuses, and make effective use of the image information and the likes stored in the past, by automatically displaying the stored image information and the likes in predetermined timing, without the users of the image information apparatuses performing any special operation.

### SUMMARY OF THE INVENTION

With the above image display apparatuses, it is possible to provide the users of the image display apparatuses with chances to review the contents of information accumulated in the past or refresh their memories by displaying the contents of information accumulated in the past, without the users performing any special operation. However, to check a person who has not talked with a user on the phone for a long period of time in the call history, the user needs to manually check the person, which causes inconvenience to the user. Therefore, the user cannot easily remember those who have not talked with the user on the phone for a long period of time.

The present invention has been made in view of the above circumstances, and it is an object of the invention to provide an image display apparatus, an image display method, and a recording medium recording an image display program that can cause the user of the image display apparatus to effectively remember those who have not talked with the user on the phone for a long period of time, and can provide the user with the topics for the next conversation with each of those who have not talked with the user on the phone for a long period of time.

In order to solve the above problem, the invention according to claim 1 relates to an image display apparatus that displays an image, comprising:

a call information acquiring unit configured to acquire other-party device history information that associates other-party device information with call history information that is records of calls, the other-party device information being related to devices of other parties that have talked with a user of the image display apparatus on the phone through a telephone device;

an other-party device information selecting unit configured to select the other-party device information about devices of other parties that talked with the user on the phone a predetermined period of time ago or earlier, by referring to the other-party device history information acquired by the call information acquiring unit;

an image information acquiring unit configured to acquire image information related to the other-party device information selected by the other-party device information selecting unit; and

a display control unit configured to cause an image according to the image information acquired by the image information acquiring unit to be displayed.

In order to solve the above problem, the invention according to claim 7 relates to an image display method of displaying an image, comprising the steps of:

acquiring other-party device history information that associates other-party device information with call history information that is records of calls, the other-party device information being related to devices of other parties that have talked on the phone through a telephone device;

selecting the other-party device information about devices of other parties that talked on the phone a predetermined period of time ago or earlier, by referring to the other-party device history information thus acquired;

acquiring image information related to the other-party device information thus selected; and

causing an image according to the image information thus acquired to be displayed.

In order to solve the above problem, the invention according to claim 8 relates to a computer-readable recording medium recording an image display program to be executed, the image display program making a computer perform the steps of:

acquiring other-party device history information that associates other-party device information with call history information that is records of calls, the other-party device information being related to devices of other parties that have talked on the phone through a telephone device;

selecting the other-party device information about devices of other parties that talked on the phone a predetermined period of time ago or earlier, by referring to the other-party device history information thus acquired;

acquiring image information related to the other-party device information thus selected; and

causing an image according to the image information thus acquired to be displayed.

### BRIEF DESCRIPTION OF THE DRAWINGS

FIG. 1 is a block diagram showing an example of a schematic structure of an image display apparatus 1 according to a first embodiment;

FIG. 2 shows an example of the contents of a telephone book database;

FIGS. 3A through 3C show examples of the contents of a last call history database;

FIG. 4 shows an example of the contents of a rare call history database;

FIGS. 5A and 5B show examples of the contents of an acquired image number database;

FIGS. 6A and 6B show examples of the contents of an image display frequency database;

FIG. 7 is a flowchart showing an example of an image display operation to be performed by the control unit 11 of the image display apparatus 1 according to the first embodiment;

FIG. 8 is a flowchart showing the details of a last call history database updating operation of step S16 shown in FIG. 7;

FIG. 9 is a flowchart showing the details of an image information acquiring operation of step S17 shown in FIG. 7;

FIG. 10 is a flowchart showing the details of an image information retrieving operation of step S35 shown in FIG. 9;

FIG. 11 shows an example of an image display time schedule table;

FIG. 12 is a block diagram showing an example of a schematic structure of an image display apparatus 1 according to a second embodiment;

FIG. 13A shows an example of the contents of an outgoing call history database;

FIG. 13B shows an example of the contents of an incoming call history database;

FIG. 14 is a flowchart showing an example of an image display operation to be performed by the control unit 11 of the image display apparatus 1 according to the second embodiment; and

FIG. 15 is a flowchart showing a last call history database updating operation of step S66 shown in FIG. 14.

### DESCRIPTION OF THE PREFERRED EMBODIMENTS

The following is a description of embodiments of the present invention, with reference to the accompanying drawings.

### First Embodiment

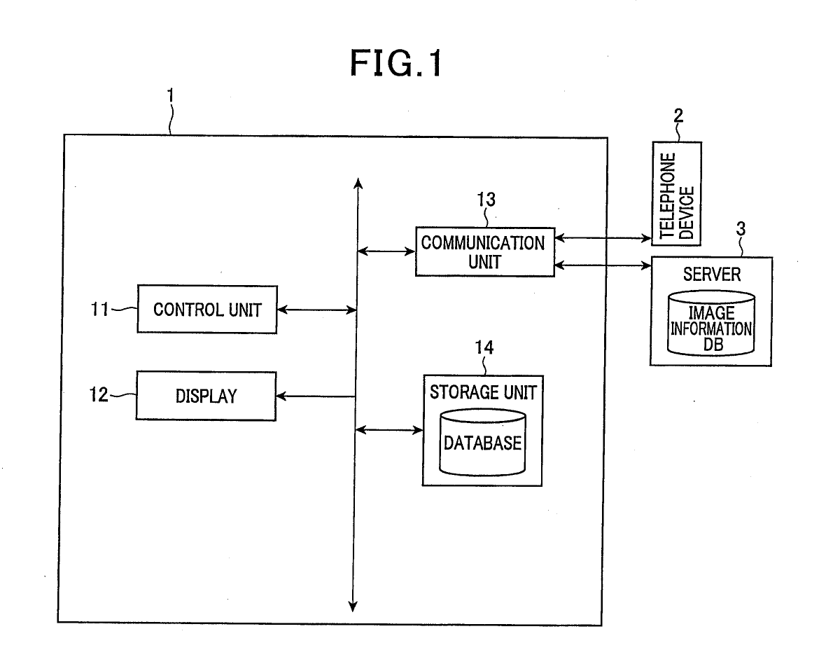

Referring first to FIG. 1, the structure and functions of an image display apparatus 1 according to a first embodiment are described.

As shown in FIG. 1, the image display apparatus 1 is designed to include a control unit 11 having a CPU, a RAM, a ROM, and the likes, a display 12, a communication unit 13, and a storage unit 14. As the image display apparatus 1, it is possible to use a personal computer, a digital photo frame device, or any kind of portable device. The image display apparatus 1 is connected to a telephone device 2 via the communication unit 13 and a communication cable. For example, the telephone device 2 is placed in a building in which the image display apparatus 1 is installed. The telephone device 2 performs communications (telephone communications) with the telephone device (hereinafter referred to as the “other-party device” of the other end of the telephone device 2 via a telephone line or the like. As the telephone device 2 and the other-party device, it is possible to use stationary telephone devices, portable telephone devices, personal computers with IP telephone functions, and the likes. In this embodiment, the image display apparatus 1 and the telephone device 2 are of independent types, or have housings independent of each other. However, the image display apparatus 1 and the telephone device 2 may be integrally formed.

The image display apparatus 1 can also be connected to a server 3 via the communication unit 13 and the Internet.

The CPU of the control unit 11 performs various kinds of operations according to an image display program of the present invention or the like under an operating system. More specifically, the CPU functions as a communication information acquiring unit, an other-party device information selecting unit, an image information acquiring unit, a display control unit, a communication history information updating unit, an acquired image number determining unit, a display frequency determining unit, and the likes of the present invention. The control unit 11 also has a clock function.

The storage unit 14 is formed with a nonvolatile semiconductor memory (such as a flash ROM), a hard disk drive, and the likes, for example. The storage unit 14 stores the OS, the image display program of the present invention, application programs, and the likes. The application programs include a slide-show program that defines an operation to display a slide show by switching images at predetermined time intervals, a multi-display program that defines a multi-display operation to display more than one image on the same screen, and the likes.

The storage unit 14 also includes an image information database, a telephone book database, a last call history database, a rare call history database, an acquired image number database, and an image display frequency database that are used to efficiently acquire image information about persons (other-party devices) with whom the user of the telephone device 2 have not talked with the use of the telephone device 2 for a long period of time. In the following, the contents of each of the databases will be described, and a brief operation of each of the components in the control unit 11 will be described.

### <Image Information Database>

A plurality of pieces of image information are stored (registered) in the image information database, though not shown in the drawings. The image information is data forming photographic images (images showing human faces and figures, for example) and other images (scenic images and illustrations, for example). The image information is stored in an image file (such as a TIFF, GIF, or JPEG file, for example). The image information stored in the image information database includes image information with which the other-party device information about the other-party devices is associated. Examples of the other-party device information include the later described ID information and telephone number information.

The control unit 11 (the image information acquiring unit) retrieves and acquires the image information to be displayed on the display 12 from the image information database. The image information database may be constructed in the server 3, or the control unit 11 may acquire the image information from the server 3 via the communication unit 13 or the like.

### <Telephone Book Database>

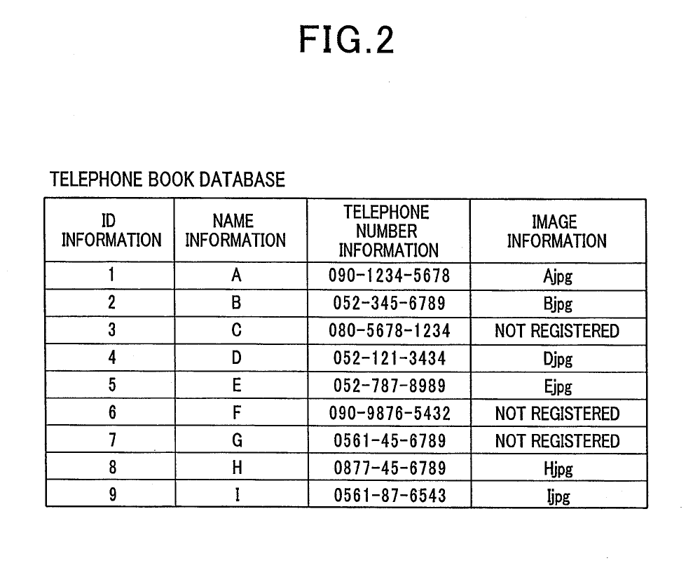

As shown in FIG. 2, ID information, name information, and telephone number information are associated with one another, and are stored (registered) for each party in the telephone book database. Here, the ID information is the information for identifying each other-party device. The name information is the information indicating the names of the parties corresponding to the respective other-party devices. The telephone number information is the information indicating the telephone numbers of the respective other-party devices. The ID information and the telephone number information can be used when the control unit 11 searches the image information database for the image information to be displayed on the display 12 (described later in detail).

As shown in FIG. 2, some of the other parties have image information registered in the telephone book database. The image information is the data about the facial image of each party, for example. The facial image can be used when the control unit 11 searches the image information database for the image information to be displayed on the display 12 (described later in detail).

The user of the image display apparatus 1 can arbitrarily register the ID information, the name information, the telephone number information, and the image information, by handling an operation unit (not shown).

The telephone book database may be provided in the telephone device 2, for example, and the control unit 11 may refer to and update the telephone book database via the communication unit 13.

### <Last Call History Database>

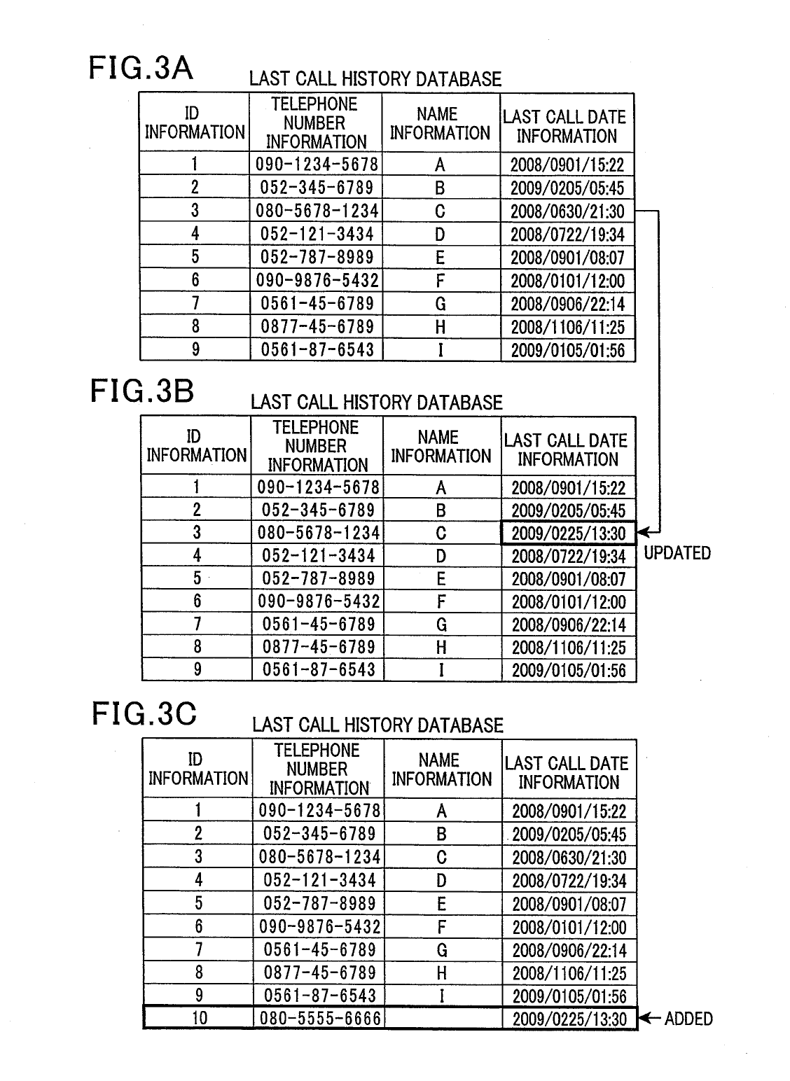

In the last call history database shown in FIG. 3A, the ID information, the telephone number information, and last call date and time information are associated with one another, and are stored for each of the other-party devices that have been connected to the telephone device 2. Here, the last call date and time information is the date and time information indicating the date and time of the last call with each other-party device (hereinafter referred to as the “last call date and time”), and is an example of the history information about the calls with each other-party device (the call history information).

When there is an outgoing call from the telephone device 2 to an other-party device, or when there is an incoming call from an other-party device to the telephone device 2, the last call date and time information is updated by the control unit 11 (the call history information updating unit) as shown in FIG. 3B. For example, when the outgoing call is an outgoing call to one of the parties indicated by the telephone number information stored in the last call history database, or when the incoming call is an incoming call from one of the parties indicated by the telephone number information stored in the last call history database, the last call date and time information associated with the corresponding telephone number information is updated.

When the outgoing call is an outgoing call to a party indicated by telephone number information that is not stored in the last call history database, or when the incoming call is an incoming call from a party indicated by telephone number information that is not stored in the latest call history database, a set of ID information, telephone number information, and latest call date and time information is added to the latest call history database by the control unit 11, as shown in FIG. 3C. The latest call history database may be provided in the telephone device 2, for example, and the control unit 11 may refer to or update the latest history database via the communication unit 13.

### <Rare Call History Database>

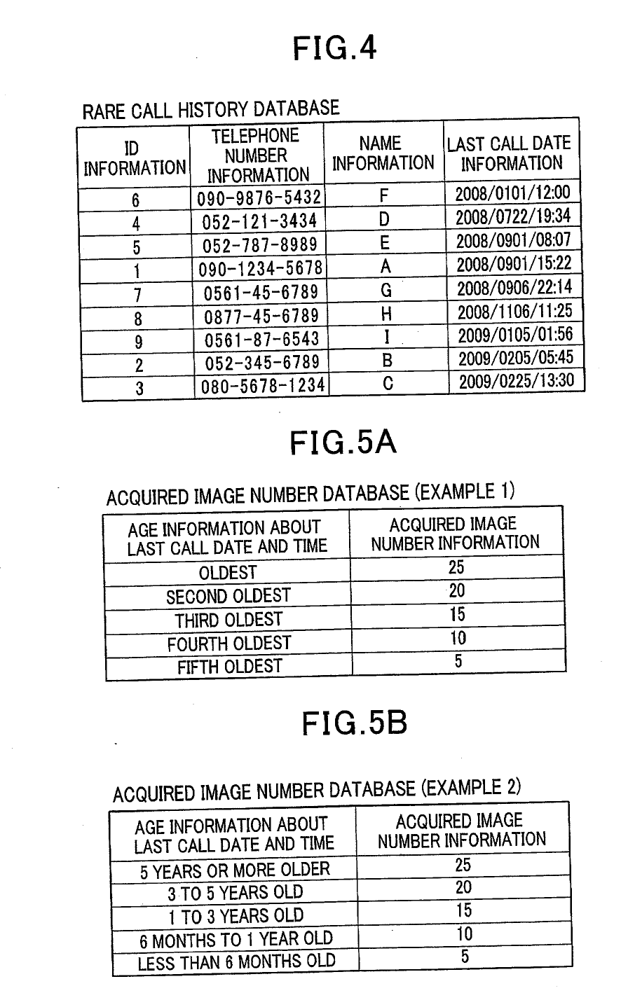

Rare call information indicating the rarity of calls is stored in the rare call history database. This rare call information is obtained by comparing the last call date and time information stored in the last call history database with the current date and time information. For example, the control unit 11 creates the rare call information by rearranging the last call date and time information and the likes, with the last call date and time indicated by the last call date and time information stored in the last call history database being in time-far (old) order based on the present date and time (in chronological order). The rare call history database shown in FIG. 4 is formed by rearranging the sets of the ID information, the telephone number information, and the last call date and time information stored in the last call history database shown in FIG. 3B, in chronological order.

For example, the control unit 11 (the call information acquiring unit) acquires, for example, a plurality of pieces of other-party device history information (the rearranged other-party device history information) that associates the last call date and time information with the telephone number information about the other-party devices that have been connected to the telephone device 2, from the rare call history database. The control unit 11 (the other-party device information selecting unit) then refers to the acquired other-party device history information, and selects the telephone number information about the other-party device connected to the telephone device 2 a certain period of time ago. For example, the control unit 11 selects a predetermined number of pieces of telephone number information from the arranged other-party device history information, in chronological order. The control unit 11 (the image information acquiring unit) searches the image information database for the image information about the selected telephone number information, and acquires the image information (described later in detail). The control unit 11 (the display control unit) outputs the acquired image information to the display 12, so that the image according to the image information is displayed on the display 12. Where more than one set of image information (images) is acquired, the images are displayed as a slide show while being switched, or are displayed on the same screen in a multi-display manner.

### <Acquired Image Number Database>

The acquired image number database is used to determine the number (an example of the number of pieces of acquired image information) of images (frames) according to the image information acquired by the control unit 11 (the image information about the telephone number information selected by the other-party device information selecting unit) (described later in detail).

As shown in FIGS. 5A and 5B, the age information about the last call dates and time and the acquired image number information are associated with each other in the acquired image number database. In the example shown in FIG. 5A, the number of images to be acquired in the case of the oldest last call date and time is set at 25, and the number of images to be acquired in the case of the second oldest last call date and time is set at 20. In the example shown in FIG. 5B, on the other hand, numbers of images to be acquired are classified by period. For example, if the last call date and time is five years or more old, the number of images to be acquired is set at 25. If the last call date and time is three to five years old, the number of images to be acquired is set at 20. The user of the image display apparatus 1 can perform this setting by handling the operating unit (not shown).

As described above, the older the last call date and time is, the more images are acquired and displayed.

### <Image Display Frequency Database>

The image display frequency database is used to determine the display frequency at which the image according to the image information acquired by the control unit 11 is displayed (described later in detail).

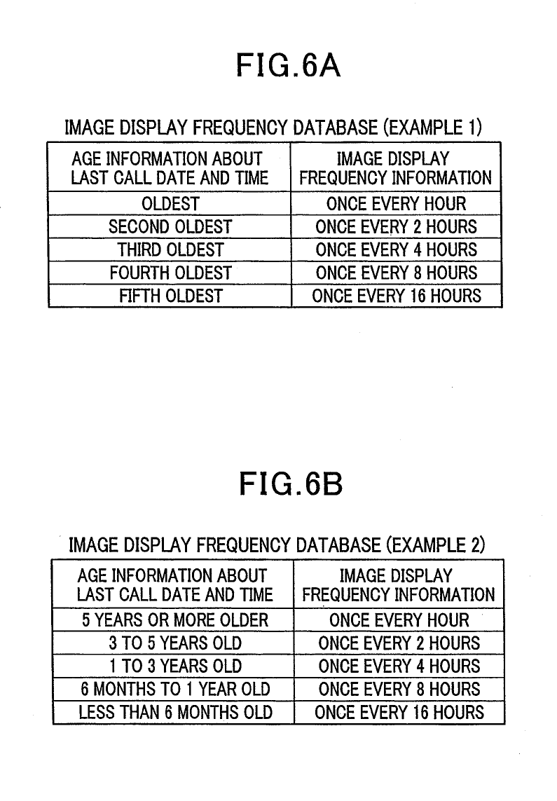

As shown in FIGS. 6A and 6B, the age information about the last call date and the image display frequency information are associated with each other in the image display frequency database. In the example shown in FIG. 6A, the display frequency in the case of the oldest last call date and time is set at once every hour, and the display frequency in the case of the second oldest last call date and time is set at once every two hours. In the example shown in FIG. 6B, on the other hand, the display frequency is classified by period. For example, if the last call date and time is five years or more old, the display frequency is set at once every hour. If the last call date and time is three to five years old, the display frequency is set at once every two hours. The user of the image display apparatus 1 can perform this setting by handling the operating unit (not shown).

As described above, the older the last call date and time is, the more often image are displayed.

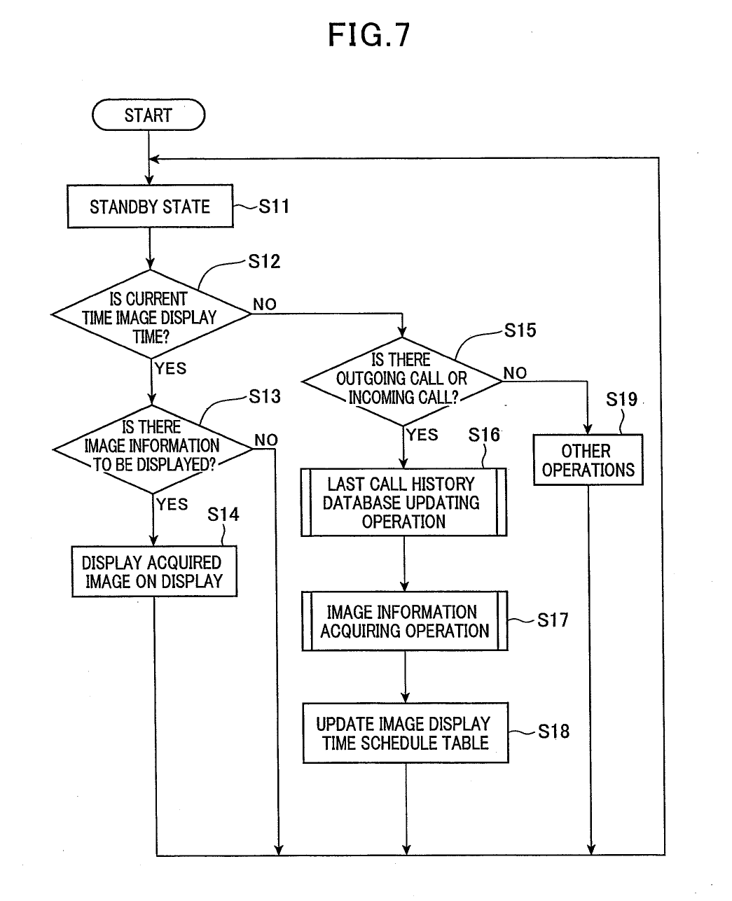

Referring now to FIGS. 7 through 10, the operations of the image display apparatus 1 according to the first embodiment are described.

### <Image Display Operation>

Referring first to FIG. 7, an image display operation is described. The image display operation shown in FIG. 7 is started by a power supply ON command for the image display apparatus 1, for example, and the operation is put into a standby state (step S11). This standby state is canceled when a timer finishes counting up or a signal is generated, and the operation moves on to step S12. If a power supply OFF command for the image display apparatus 1 is issued in the standby state, the operation shown in FIG. 7 comes to an end.

At step S12, the control unit 11 determines whether the current time obtained by the clock function is a predetermined image display time. This determination is made in accordance with an image display time schedule table that is prepared beforehand and stored in the RAM.

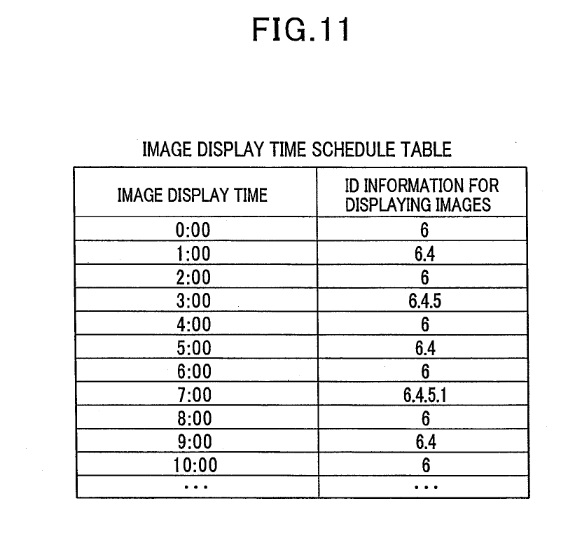

The image display time schedule table shown in FIG. 11 is formed based on the rare call history database shown in FIG. 4 and the image display frequency database shown in FIG. 6A. For example, since the last call date and time associated with the ID information “6” is the oldest, as shown in FIG. 4, the ID information “6” is set every hour in the image display time schedule table shown in FIG. 11. Also, since the last call date and time associated with the ID information “4” is the second oldest, as shown in FIG. 4, the ID information “4” is set every two hours in the image display time schedule table shown in FIG. 11.

In a case where the control unit 11 determines that the current time is an image display time (midnight (00:00), for example) (“YES” at step S12), the control unit 11 acquires the ID information associated with the image display time from the image display time schedule table, and the operation moves on to step S13. In a case where the control unit 11 determines that the current time is not an image display time (“NO” at step S12), the operation moves on to step S15.

At step S13, the control unit 11 determines whether there is image information to be displayed. For example, the control unit 11 determines whether image information associated with the ID information acquired at step S12 is stored in a display image storage area provided in the RAM. In this display image storage area, the image information to be acquired through the later described image acquiring operation (step S17) is stored together with the ID information.

In a case where the control unit 11 determines that there is image information to be displayed (YES at step S13), the control unit 11 reads the image information to be displayed from the display image storage area, and outputs the image information to the display 12. By doing so, the control unit 11 causes the display 12 to display the image according to the image information (step S14). Here, if there is more than one set of image information to be displayed, the control unit 11 activates the slide-show program or the multi-display program, and displays the images according to the image information as a slide show while switching the images one by one, or displays the images on the same screen.

In a case where the control unit 11 determines that there is no image information to be displayed (“NO” at step S13), the operation returns to step S11.

At step S15, the control unit 11 determines whether there is an outgoing call from the telephone device 2 to an intended party, or whether there is an incoming call from another party to the telephone device 2. In a case where the control unit 11 determines that there is an outgoing call or an incoming call (or where a signal indicating an outgoing call or an incoming call is received from the telephone device 2) (“YES” at step S15), the operation moves on to step S16. At step S16, a last call history database updating operation is performed. In a case where the control unit 11 determines that there is not an outgoing call or an incoming call (“NO” at step S15), the operation moves on to step S19. At step S19, other operations are performed. The other operations include various kinds of setting operations and the operations to register information in the databases in accordance with operation instructions from the user of the image display apparatus 1, for example.

### <Last Call History Database Updating Operation>

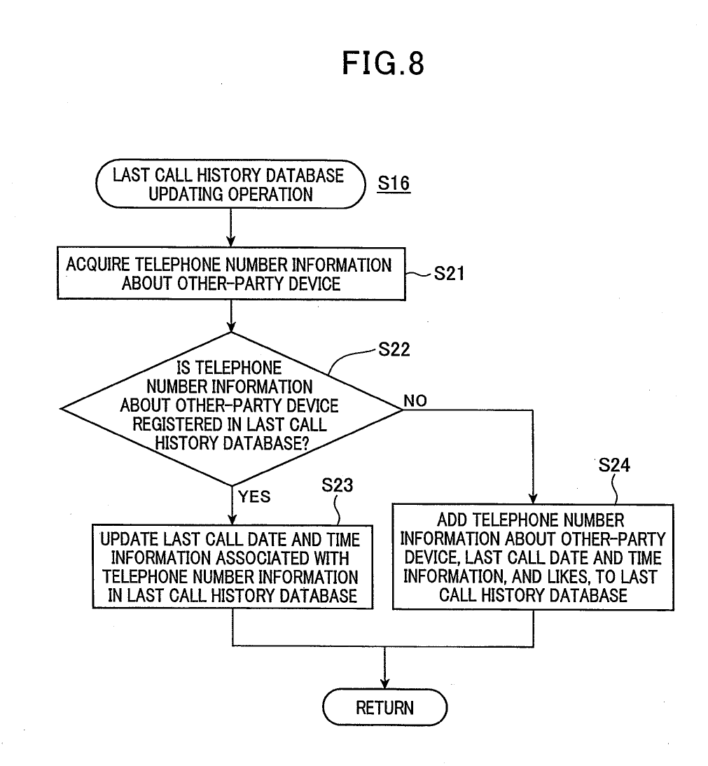

Referring now to FIG. 8, the last call history database updating operation is described.

In the operation shown in FIG. 8, the control unit 11 first acquires the telephone number information about the other-party device connected to the telephone device 2 through the outgoing or incoming call, from the telephone device 2 (step S21).

The control unit 11 then determines whether the acquired telephone number information about the other-party device is stored in the last call history database (see FIG. 3A) (step S22). In a case where the control unit 11 determines that the telephone number information about the other-party device is stored in the last call history database (“YES” at step S22), the operation moves on to step S23. In a case where the control unit 11 determines that the telephone number information is not stored in the last call history database (“NO” at step S22), the operation moves on to step S24.

At step S23, the control unit 11 updates the last call date and time information associated with the telephone number information stored in the last call history database (see FIG. 3B). This operation then returns to the operation shown in FIG. 7, and moves on to the image information acquiring operation of step S17.

At step S24, on the other hand, the control unit 11 adds the telephone number information about the other-party device, the last call date and time information indicating the date and time of the call, and the ID information to the last call history database (see FIG. 3C). This operation then returns to the operation shown in FIG. 7, and moves on to the image information acquiring operation of step S17. If the ID information is associated with the telephone number information and is stored in the telephone book database, the ID information is used here. If the ID information is not stored in the telephone book database, the ID information is newly generated.

### <Image Information Acquiring Operation>

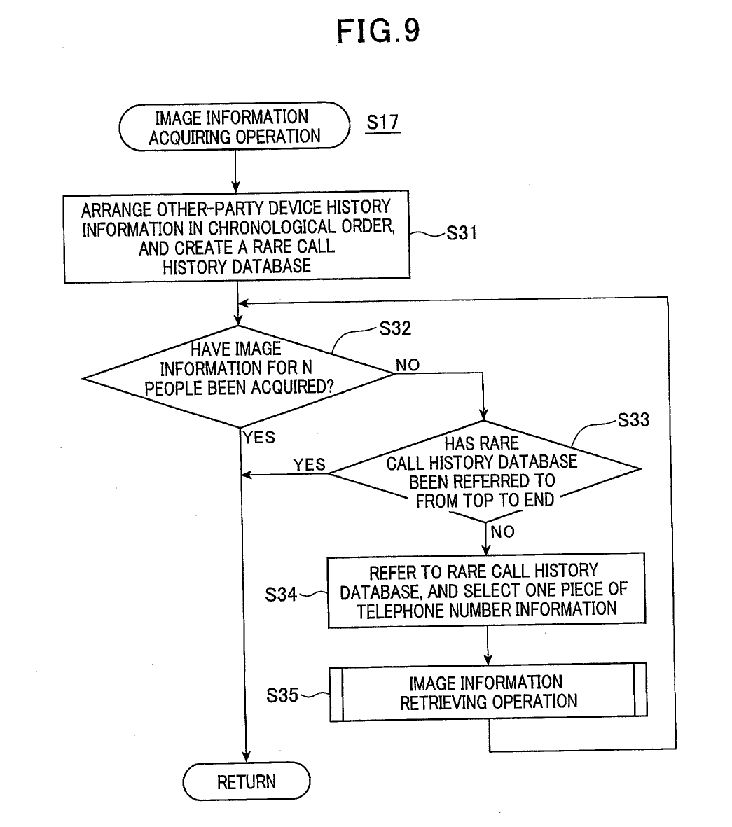

Referring now to FIG. 9, the image information acquiring operation is described.

In the operation shown in FIG. 9, the control unit 11 first acquires sets of ID information, telephone number information, and last call date and time information associated with one another (the other-party device history information), from the last call history database). The control unit 11 compares each last call date and time indicated by the last call date and time information with the current date and time information, and rearranges the acquired other-party device history information in chronological order, to create the rare call history database (see FIG. 4) (step S31). In this manner, the rare call information indicating the rarities of calls is obtained.

The control unit 11 then determines whether it has acquired a predetermined number N of pieces of image information (N being a natural number and an example of a predetermined number) (step S32). In a case where the control unit 11 determines that it has not acquired N pieces of image information (“NO” at step S32), the operation moves on to step S33. In a case where the control unit 11 determines that it has acquired N pieces of image information (“YES” at step S32), this operation returns to the operation shown in FIG. 7, and moves on to step S18.

At step S33, the control unit 11 determines whether it has referred (one by one from the top to the bottom) to the created rare call history database from the top (or the other-party device history information with the oldest last call date and time) to the bottom (or the other-party device history information with the newest last call date and time). In a case where the control unit 11 determines that it has not referred to the rare call history database from the top to the bottom (“NO” at step S33), the operation moves on to step S34. In a case where the control unit 11 determines that it has referred to the rare call history database from the top to the bottom (“YES” at step S33), this operation returns to the operation shown in FIG. 7, and moves on to step S18.

At step S34, the control unit 11 refers to the rare call history database, and selects one piece of telephone number information from the rearranged other-party device history information. Here, the selected telephone number information is telephone number information that has not been selected from the rare call history database, and is the oldest in the other-party device history information at this point.

The control unit 11 then performs an image information retrieving operation, and acquires the image information associated with the selected telephone number information from the image information database (if the corresponding image information is not registered, the control unit 11 does not acquire any image information). The control unit 11 then stores the acquired image information and the ID information corresponding to the telephone number information into the above mentioned display image storage area (step S35).

The procedures of steps S32 through S35 are repeated, to select a predetermined number of pieces of telephone number information (or a predetermined number of the oldest pieces of telephone information in chronological order) about the other-party devices having the oldest last call histories (the other-party devices connected a predetermined period of time ago). If the image information corresponding to the telephone number information is found, the image information is acquired.

### <Image Information Retrieving Operation>

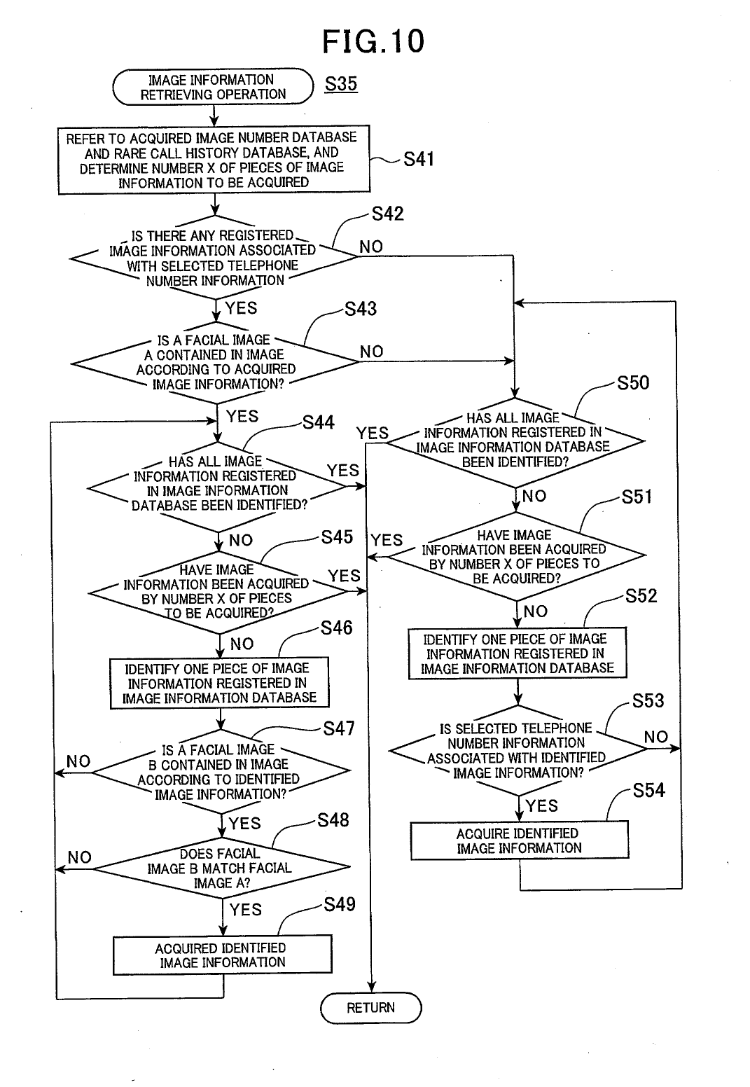

Referring now to FIG. 10, the image information retrieving operation is described.

In the operation shown in FIG. 10, the control unit 11 first refers to the rare call history database created at step S31 and the acquired image number database prepared in advance (see FIG. 5), and determines the number X of pieces of image information to be acquired with respect to the selected telephone number information (step S41). More specifically, based on the rare call information shown in the rare call history database, the number X of pieces of image information to be acquired with respect to the selected telephone number information is determined. For example, in a case where the selected telephone number information is “090 9876 5432” (with the ID information being “6”) shown in FIG. 4, the last call date and time of this other-party device is the oldest of all. Therefore, when the acquired image number database shown in FIG. 5A is referred to, the number X of pieces of image information to be acquired with respect to the selected telephone number information is determined to be 25. In this manner, the number X of pieces of image information to be acquired is determined based on how old the last call is.

The control unit 11 then determines whether the image information associated with the selected telephone number information is registered in the telephone book database (see FIG. 2) (step S42). In a case where the control unit 11 determines that the image information is registered in the telephone book database (“YES” at step S42), the control unit 11 acquires the image information from the telephone book database, and the operation moves on to step S43. In a case where the control unit 11 determines that the image information is not registered in the telephone book database (“NO” at step S42), the operation moves on to step S50.

At step S43, the control unit 11 determines whether the image according to the image information acquired from the telephone book database contains a facial image (hereinafter referred to as the “facial image A”). In a case where the control unit 11 determines that the image according to the image information contains the facial image A (or the facial image A can be extracted) (“YES” at step S43), the control unit 11 extracts the facial image A, and the operation moves on to step S44. In a case where the control unit 11 determines that the image according to the image information does not contain the facial image A (“NO” at step S43), the operation moves on to step S50.

At step S44, the control unit 11 determines whether it has identified all the image information registered in the image information database at step S46 mentioned below (the operation of step S46 is to identify one piece of image information from the image information database), or whether it has searched the entire image information database. In a case where the control unit 11 determines that it has not identified all the image information registered in the image information database (“NO” at step S44), the operation moves on to step S45. In a case where the control unit 11 determines that it has identified all the image information registered in the image information database (“YES” at step S44), this operation returns to the operation shown in FIG. 9.

At step S45, the control unit 11 determines whether it has acquired the predetermined number X of pieces of image information. In a case where the control unit 11 determines that it has not acquired the number X of pieces of image information (“NO” at step S45), the operation moves on to step S46. In a case where the control unit 11 determines that it has acquired the number X of pieces of image information (“YES” at step S45), this operation returns to the operation shown in FIG. 9.

At step S46, the control unit 11 identifies one piece of image information that is registered in the image information database and has not been identified yet.

The control unit 11 then determines whether the image according to the image information identified at step S46 contains a facial image (hereinafter referred to as the “facial image B”) (step S47). In a case where the control unit 11 determines that the image according to the image information contains the facial image B (“NO” at step S47), the operation returns to step S44. In a case where the control unit 11 determines that the image according to the image information contains the facial image B (or that the facial image B can be extracted) (“YES” at step S47), the control unit 11 extracts the facial image B, and the operation moves on to step S48.

At step S48, the control unit 11 determines whether the extracted facial image B matches the extracted facial image A. In a case where the control unit 11 determines that the facial image B does not match the facial image A (“NO” at step S48), the operation returns to step S44. In a case where the control unit 11 determines that the facial image B matches the facial image A (“YES” at step S48), the operation moves on to step S49.

The determination on whether the facial image B matches the facial image A is made by comparing the two facial images with each other to determine whether there are similarities between the two. If there are similarities, the facial image A and the facial image B are determined to match. Since this technique of finding similarities is a known technique, detailed explanation of it is omitted herein. For example, facial feature points (such as the eyes, nose, and mouth) that well represent the facial features are extracted from the facial image A, and a face graph is formed by connecting those feature points. The degree of coincidence between the face graph and another face graph created from the facial image B in the same manner as above is then calculated. If the degree of coincidence is equal to or higher than a predetermined value, the two facial images are determined to have similarities. If the faces shown in the facial image A and the facial image B are orientated in different directions from each other, similarities are not found, and the facial feature points cannot be detected accurately. Therefore, the orientations of the faces are estimated first (the orientations of the faces are estimated from the triangles each having the right eye point, the left eye point, and the mouth point as its three corners), and the face graphs are transformed in accordance with the orientations. In this manner, the above problem can be solved.

At step S49, the control unit 11 acquires the image information identified at step S46 (the image information containing the facial image B that matches the facial image A), and stores the acquired image information and the ID information corresponding to the selected telephone number information into the display image storage area provided in the RAM. After that, the operation returns to step S44, and the above described procedures are repeated until the number X of pieces of image information is acquired or all the image information registered in the image information database is identified. Through those procedures, the number X of pieces of image information associated with the ID information corresponding to the selected telephone number information is acquired and stored as the image information to be displayed (or a predetermined number of pieces of image information related to the selected telephone number information is acquired, based on the above determined number of pieces of image information to be acquired). With this arrangement, the image information about rarely called parties can be automatically and efficiently retrieved as the image information to be displayed, as long as the image information is registered in the image information database.

At step S50, in a case where the image according to the image information does not contain the facial image A, the control unit 11 determines whether it has identified all the image information registered in the image information database at the later described step S52 (the operation of step S52 is to identify one piece of image information from the image information database), or whether it has referred to (or searched) the entire image information database. In a case where the control unit 11 determines that it has not identified all the image information registered in the image information database (“NO” at step S50), the operation moves on to step S51. In a case where the control unit determines that it has identified all the image information registered in the image information database (“YES” at step S50), this operation returns to the operation shown in FIG. 9.

At step S51, the control unit 11 determines whether it has acquired the above determined number X of pieces of image information. In a case where the control unit 11 determines that it has not acquired the number X of pieces of image information (“NO” at step S51), the operation moves on to step S52. In a case where the control unit determines that it has acquired the number X of pieces of image information (“YES” at step S51), this operation returns to the operation shown in FIG. 9.

At step S52, the control unit 11 identifies one piece of image information that is registered in the image information database and has not yet been identified.

The control unit 11 then determines whether the image information identified at step S52 is associated with the above selected telephone number information (step S53). In a case where the control unit 11 determines that the image information is not associated with the telephone number information (“NO” at step S53), the operation moves on to step S50. In a case where the control unit 11 determines that the image information is associated with the selected telephone number information (“YES” at step S53), the control unit 11 acquires the image information (step S54), and stores the acquired image information and the ID information corresponding to the selected telephone number information into the display image storage area provided in the RAM. After that, the operation returns to step S50, and the above procedures are repeated until the number X of pieces of image information is acquired, or all the image information registered in the image information database is identified. With this arrangement, the image information about rarely called parties can be automatically and efficiently retrieved as the image information to be displayed, as long as the image information associated with the telephone number information is registered in the image information database.

At step S18 after returning to the operation shown in FIG. 7, the control unit 11 refers to the rare call history database created at step S31 and the image display frequency database prepared in advance (see FIG. 6), and determines the display frequency at which the image according to the acquired image information is displayed. In this manner, the control unit 11 updates the image display time schedule table. More specifically, based on the rate call information shown in the rare call history database, the control unit 11 determines the display frequency at which the image according to the acquired image information is displayed. Based on the determined display frequency, the image according to the acquired image information is displayed. For example, the last call date and time associated with the ID information “6” is the oldest as shown in FIG. 4. Therefore, when the image display frequency database shown in FIG. 6A is referred to, the display frequency for the image information associated with the ID information “6” is determined to be “once every hour”, and the ID information “6” is set (or updated) every hour in the image display time schedule table as shown in FIG. 11. In updating the image display time schedule table, the ID information associated with the newly acquired image information is added to the image display time schedule table, or the ID information associated with the telephone number information about the other-party device that performed the call is deleted from the image display time schedule table.

As described above, in the first embodiment, based on the image display time schedule table created in advance, the images related to a person who has not talked with the user of the image display apparatus 1 on the phone for a long period of time can be automatically displayed to the user of the image display apparatus 1, without the user manually checking the images. Accordingly, it is possible for the user to promptly remember the person who has not talked with the user on the phone for a long period of time. Also, it is possible to provide the user with the topics for the next conversation with the person who has not talked with the user on the phone for a long period of time.

Since the last call date and time information is updated every time a call is made through the telephone device 2, it is also possible for the user to accurately realize who have not talked with the user on the phone for a long period of time up to today. Accordingly, it is possible for the user to check the images related to those who have not talked with the user on the phone for a long period of time, and efficiently remember those who have not talked with the user on the phone for a long period of time.

Also, by selecting a predetermined number of pieces of other-party device history information in chronological order, images can be sequentially displayed to the user of the image display apparatus 1, with the images related to the person who has not talked with the user longest being the first ones on display. Accordingly, it is possible for the user to easily and quickly remember those who have not talked with the user on the phone for a long period of time.

Further, the number of images that are related to a person who has not talked with the user on the phone for a long period of time and are to be displayed to the user of the image display apparatus 1 is determined based on the period of time during which there has not been a call. Accordingly, it is possible for the user to easily and quickly remember those who have not talked with the user on the phone for a long period of time.

Further, the frequency at which the images related to a person who has not talked with the user on the phone for a long period of time are to be displayed to the user of the image display apparatus 1 is determined based on the period of time during which there has not been a call. Accordingly, it is possible for the user to easily and quickly remember those who have not talked with the user on the phone for a long period of time.

### Second Embodiment

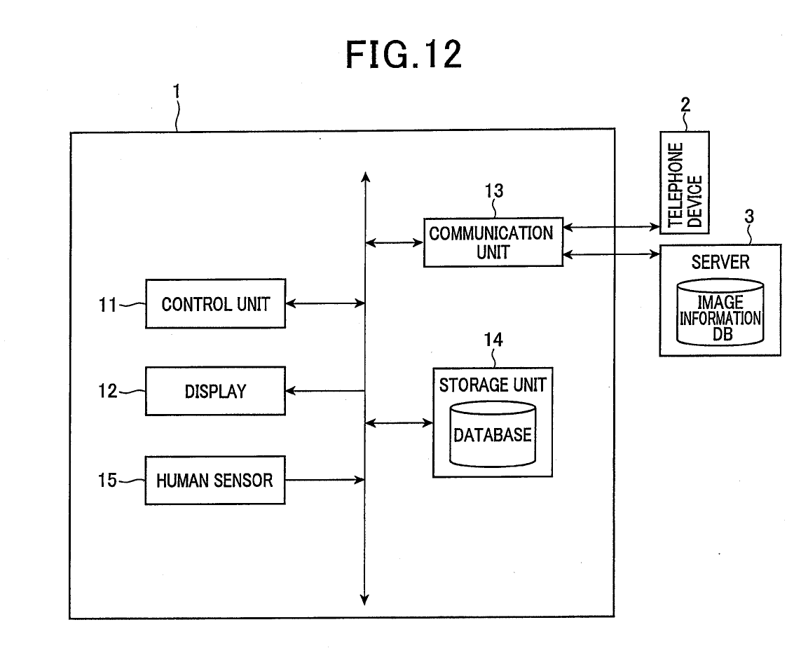

Referring to FIG. 12, an image display apparatus 1 according to a second embodiment is described.

The structure and functions of the image display apparatus 1 according to the second embodiment are basically the same as those of the first embodiment, except that the image display apparatus 1 according to the second embodiment has a human sensor 15 (an example of the human detecting unit) added to the structure of the image display apparatus 1 according to the first embodiment, as shown in FIG. 12. The human sensor 15 detects the existence of a human being. This human sensor 15 can sense a human being entering a room in which the image display apparatus 1 is installed, for example.

In the storage unit 13 of the image display apparatus 1 according to the second embodiment, an outgoing call history database and an incoming call history database are constructed as well as the databases described in the description of the first embodiment.

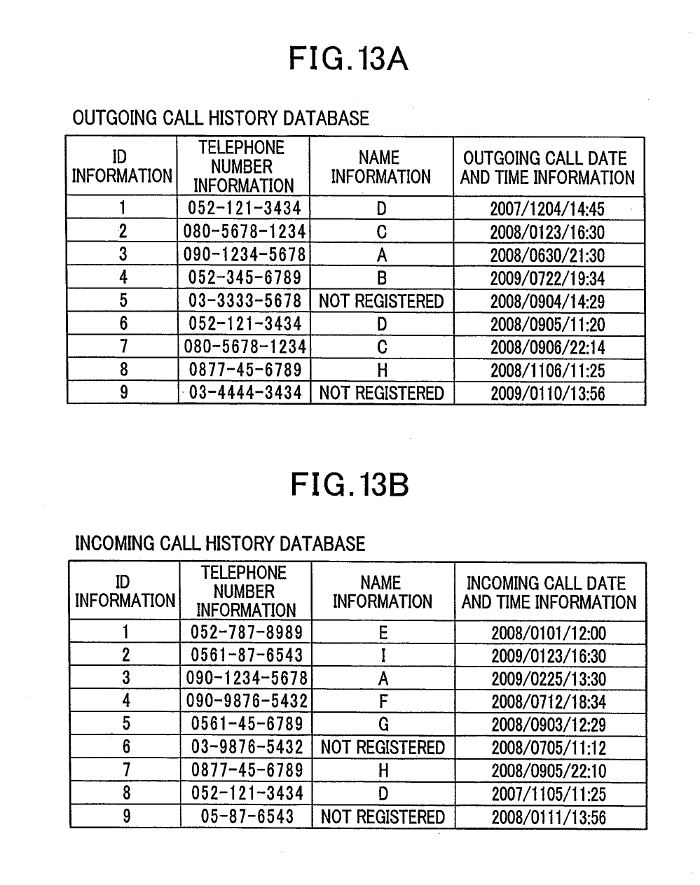

As shown in FIG. 13A, outgoing call date and time information associated with ID information and the likes is stored in the outgoing call history database. As shown in FIG. 13B, incoming call date and time information associated with the ID information and the likes is stored in the incoming call history database.

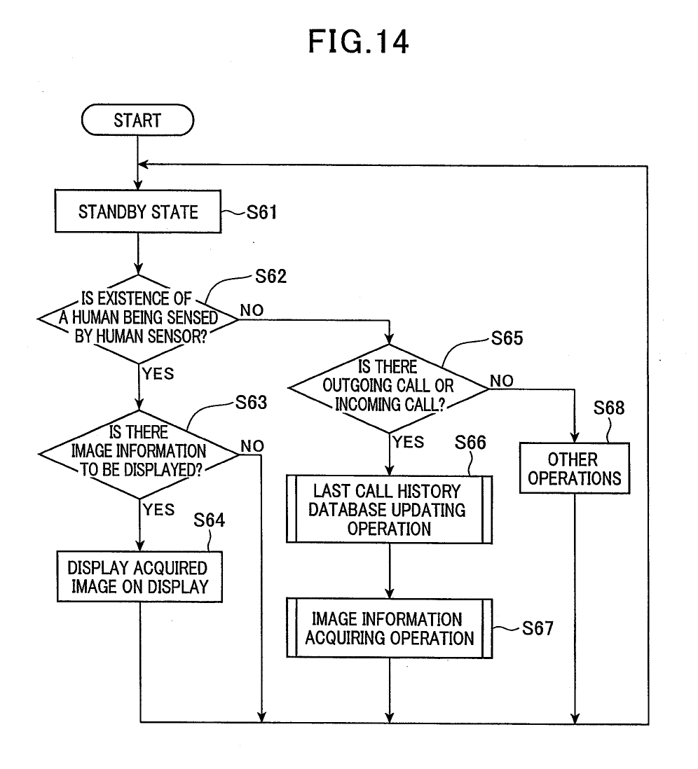

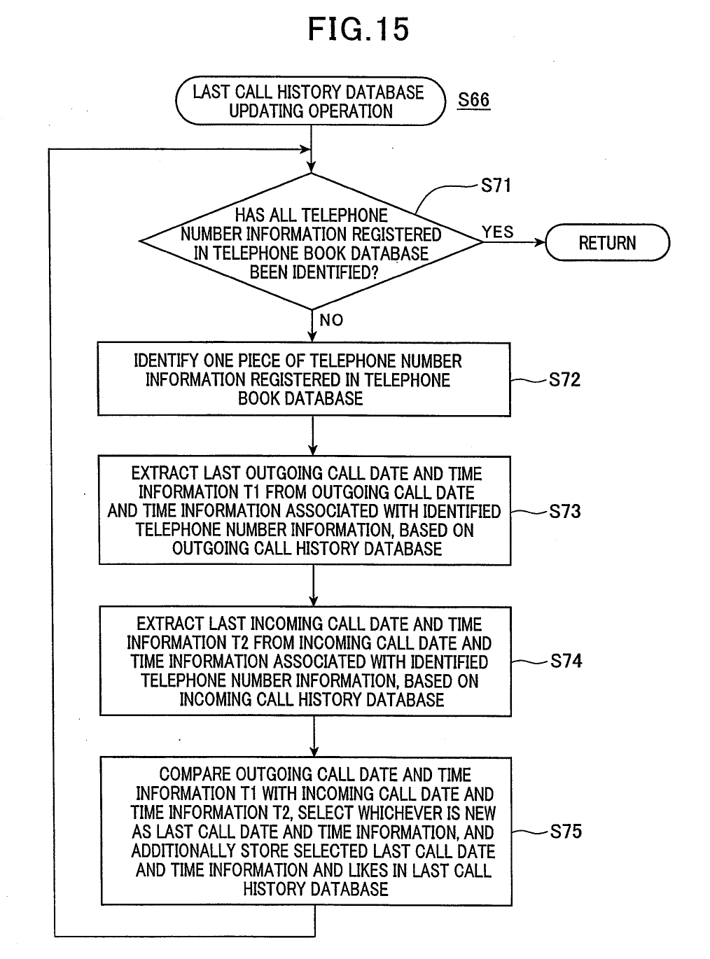

Referring now to FIGS. 14 and 15, the operations of the image display apparatus 1 according to the second embodiment are described.

### <Image Display Operation>

Referring first to FIG. 14, an image display operation is described. Like the image display operation shown in FIG. 7, the image display operation shown in FIG. 14 starts by a power supply ON command of the image display apparatus 1, and the operation is put into a standby state (step S61). This standby state is canceled when a timer finishes counting up or a signal is generated, and the operation moves on to step S62.

At step S62, the control unit 11 determines whether the existence of a human being has been sensed by the human sensor 15. In a case where the control unit 11 determines that the existence of a human being has been sensed (“YES” at step S62), the operation moves on to step S63. In a case where the control unit 11 determines that the existence of a human being has not been sensed (“NO” at step S62), the operation moves on to step S65.

The procedures of step S63, step S64, step S65, step S67, and step S68 are the same as the procedures of step S13, step S14, step S15, step S17, and step S19, respectively. Therefore, explanation of them is not repeated here.

### <Last Call History Database Updating Operation>

Referring now to FIG. 15, a last call history database updating operation is described. The last call history database updating operation is another embodiment of the last call history database updating operation shown in FIG. 8. In a case where the control unit 11 determines that there is an outgoing call or an incoming call at step S65 shown in FIG. 14 (or when a signal indicating an outgoing call or an incoming call is received from the telephone device 2) (“YES” at step S65), the last call history database updating operation shown in FIG. 8 is performed.

In the last call history database updating operation shown in FIG. 15, the control unit 11 first determines whether it has identified all the telephone number information registered in the telephone book database (or it has referred to (or searched) the entire telephone book database) (step S71). In a case where the control unit 11 determines that it has not identified all the telephone number information registered in the telephone book database (“NO” at step S71), the operation moves on to step S72. In a case where the control unit 11 determines that it has identified all the telephone number information registered in the telephone book database (“YES” at step S71), this operation returns to the operation shown in FIG. 14.

At step S72, the control unit 11 identifies one piece of telephone number information that is registered in the telephone book database and has not yet been identified.

Based on the outgoing call history database (see FIG. 13A), the control unit 11 then extracts the last outgoing call date and time information T1 (with the latest date and time (the closest to the current date and time) from the outgoing call date and time information associated with the telephone number information identified at step S72 (step S73). If no outgoing date and time information associated with the telephone number information is registered in the outgoing call history database, the extraction of the outgoing date and time information T1 is not performed.

Based on the incoming call history database (see FIG. 13B), the control unit 11 extracts the last incoming call date and time information T2 from the incoming date and time information associated with the telephone number information identified at step S72 (step S74). If no incoming date and time information associated with the telephone number information is registered in the incoming call history database, the extraction of the incoming date and time information T2 is not performed.

The control unit 11 then compares the extracted outgoing call date and time information T1 with the extracted incoming call date and time information T2, and selects whichever is the later as the last call date and time information. The control unit 11 additionally stores the selected last call date and time information, the telephone number information identified at step S72, and the ID information associated with the telephone number information into the last call history database (step S75). The operation then returns to step S71. If neither the outgoing call date and time information T1 nor the incoming call date and time information T2 is extracted, the additional storing of the last call date and time information and the likes into the last call history database is not performed. In a case where either the outgoing call date and time information T1 or the incoming call date and time information T2 is extracted, the extracted call date and time information is selected as the last call date and time information.

In the first and second embodiments, in a case where a telephone number is not included in the outgoing call history database, and is not included in the incoming call history database (i.e., in a case where although a telephone number is included in the telephone book database, there is no outgoing/incoming call of the telephone number), it may be possible to pick up, the date and time when a power of an apparatus was turned-on at first, as the last call date and time. In this case, it may be also possible to pick up, the date and time when the telephone number was registered in the telephone book database, as the last call date and time.

Through the last call history database updating operation, the last call date and time information corresponding to the respective pieces of telephone number information registered in the telephone book database can be updated.

As described above, according to the second embodiment, when the human sensor 15 senses the existence of a human being, the images related to those who have not has not talked with the user of the image display apparatus 1 on the phone for a long period of time can be automatically displayed to the user, without the user manually checking the images. Accordingly, it is possible for the user to quickly remember those who have not talked with the user on the phone for a long period of time. It is also possible to provide the user with the topics for the next conversation with a person who has not talked with the user on the phone for a long period of time. Further, since the images related to a person who has not talked with the user on the phone for a long period of time are displayed when the existence of the person is sensed, it is possible for the user to quickly remember the person who has not talked with the user on the phone for a long period of time with more accuracy, while saving on electricity.

The present invention is not confined to the configuration listed in the foregoing embodiments, but it is easily understood that the person skilled in the art can modify such configurations into various other modes, within the scope of the present invention described in the claims.

What is claimed is:

1. An image display apparatus that displays an image, comprising:
a call information acquiring unit configured to acquire other-party device history information that associates other-party device information with call history information that is records of calls, the other-party device information being related to devices of other parties that have talked with a user of the image display apparatus on the phone through a telephone device;
an other-party device information selecting unit configured to select the other-party device information about devices of other parties that talked with the user on the phone a predetermined period of time ago or earlier, by referring to the other-party device history information acquired by the call information acquiring unit;
an image information acquiring unit configured to acquire image information related to the other-party device information selected by the other-party device information selecting unit; and
a display control unit configured to cause an image according to the image information acquired by the image information acquiring unit to be displayed.

2. The image display apparatus according to claim 1, further comprising:
a call history information updating unit configured to update the call history information associated with other-party device information about an other-party device that is called from the telephone device.

3. The image display apparatus according to claim 1,
wherein the other-party device information selecting unit compares the other-party device history information acquired by the call information acquiring unit with current date and time information, rearranges the other-party device history information in chronological order, and selects a predetermined number of pieces of other-party device information contained in the rearranged other-party device history information, in chronological order.

4. The image display apparatus according to claim 1, further comprising:
an acquired image number determining unit configured to determine the number of pieces of image information to be acquired by the image information acquiring unit with respect to the other-party device information selected by the other-party device information selecting unit, based on rare call information that indicates estrangement of calls and is obtained by comparing the other-party device history information acquired by the call information acquiring unit with current date and time information,
wherein, based on the number of pieces of image information to be acquired determined by the acquired image number determining unit, the image information acquiring unit acquires a predetermined number of pieces of image information related to the other-party device information selected by the other-party device information selecting unit.

5. The image display apparatus according to claim 1, further comprising:
a display frequency determining unit configured to determine a display frequency at which an image according to the image information acquired by the image information acquiring unit is displayed by the display control unit, based on rare call information that indicates estrangement of calls and is obtained by comparing the other-party device history information acquired by the call information acquiring unit with current date and time information,
wherein, based on the display frequency determined by the display frequency determining unit, the display control unit causes the image according to the image information acquired by the image information acquiring unit to be displayed.

6. The image display apparatus according to claim 1, further comprising:
a human sensing unit configured to sense the existence of a human being,
wherein, when the human sensing unit senses the existence of a human being, the display control unit causes an image according to the image information acquired by the image information acquiring unit to be displayed.

7. An image display method of displaying an image, comprising the steps of:
acquiring other-party device history information that associates other-party device information with call history information that is records of calls, the other-party device information being related to devices of other parties that have talked on the phone through a telephone device;
selecting the other-party device information about devices of other parties that talked on the phone a predetermined period of time ago or earlier, by referring to the other-party device history information thus acquired;
acquiring image information related to the other-party device information thus selected; and
causing an image according to the image information thus acquired to be displayed.

8. A computer-readable recording medium recording an image display program to be executed, the image display program making a computer perform the steps of:
acquiring other-party device history information that associates other-party device information with call history information that is records of calls, the other-party device information being related to devices of other parties that have talked on the phone through a telephone device;
selecting the other-party device information about devices of other parties that talked on the phone a predetermined period of time ago or earlier, by referring to the other-party device history information thus acquired;
acquiring image information related to the other-party device information thus selected; and
causing an image according to the image information thus acquired to be displayed.
